(19) United States
(12) Patent Application Publication
(10) Pub. No.: US 2015/0001944 A1
(43) Pub. Date: Jan. 1, 2015

(54) METHOD FOR PROVIDING CONTROL POWER

(71) Applicants: Georg Markowz, Alzenau (DE); Carsten Kolligs, Bottrop (DE); Wolfgang Schweissthal, Mandelbachtal (DE); Wolfgang Deis, Heidelberg (DE); Holger Brezski, Fernwald (DE); Michael Igel, Saarbruecken (DE); Anna Flemming, Frankfurt (DE); Dennis Gamrad, Voerde (DE); Sebastien Cochet, Oberhausen (DE)

(72) Inventors: Georg Markowz, Alzenau (DE); Carsten Kolligs, Bottrop (DE); Wolfgang Schweissthal, Mandelbachtal (DE); Wolfgang Deis, Heidelberg (DE); Holger Brezski, Fernwald (DE); Michael Igel, Saarbruecken (DE); Anna Flemming, Frankfurt (DE); Dennis Gamrad, Voerde (DE); Sebastien Cochet, Oberhausen (DE)

(73) Assignees: Evonik Industries AG, Essen (DE); Evonik Degussa GmbH, Essen (DE); STEAG Power Saar GmbH, Saarbruecken (DE)

(21) Appl. No.: 14/357,268

(22) PCT Filed: Oct. 26, 2012
(86) PCT No.: PCT/EP2012/071257

§ 371 Date: May 9, 2014

(30) Foreign Application Priority Data
Nov. 10, 2011 (DE) 10 2011 055 225.1

(51) Int. Cl. H02J 11/00

(52) U.S. Cl. CPC H02J 11/00
USPC 307/66

(57) ABSTRACT

A method and device providing control power for an electrical grid. An energy generator feeds energy to the electrical grid as necessary, an energy consumer takes up energy from the electrical grid as necessary, and an energy store is connected to the electrical grid for providing the control power. The energy store starting from a first time point outputs to the electrical grid at least a difference between power provided by the energy generator and a nominal power or takes up from the electrical grid at least a difference between the power taken up by the energy consumer and the nominal power. The energy store provides at least this difference between the nominal power and the power provided by the energy generator or the power taken up by the energy consumer until power of the energy generator or of the energy consumer reaches the nominal power at a second time point.

The invention relates to a method for providing control power for an electrical grid, wherein an energy generator connected to the electrical grid feeds energy to the electrical grid as necessary or an energy consumer connected to the electrical grid takes up energy from the electrical grid as necessary. The invention also relates to a device for carrying out such a method.

Electrical grids are used to distribute electricity from usually a number of energy generators in large areas to many users and to supply households and industry with energy. Energy generators, usually in the form of power stations, provide the energy required for this. Electricity generation is generally planned and provided to meet the forecast consumption.

Both when generating and when consuming energy, it is possible however for unplanned fluctuations to occur. These may arise on the energy generator side for example as a result of a power station or part of the electrical grid failing or, for example in the case of renewable energy sources such as wind, the energy generation being greater than forecast. It is also possible with respect to the consumers for unexpectedly high or low levels of consumption to occur. The failure of part of the electrical grid, for example, cutting off some consumers from the energy supply, may lead to a sudden reduction in the electricity consumption.

This generally leads to fluctuations in the grid frequency in electrical grids due to unplanned and/or short-term deviations of the power generation and/or consumption. In Europe, for example, the desired AC frequency is 50.000 Hz. This frequency is often also referred to as the desired frequency. A reduction in consumption from the planned level leads to an increase in the frequency of power generated as planned by the energy generators; the same applies to an increase in the electricity production as compared with the planned level when consumption is as planned. A reduction in power from the planned level of the energy generators leads, by contrast, to a reduction in the grid frequency when consumption is as planned, and the same applies to an increase in consumption relative to the planned level when generation is as planned.

For reasons of grid stability, it is necessary to keep these deviations within defined boundaries. For this purpose, depending on the magnitude and direction of the deviation, it is necessary to provide, in a targeted manner, positive control power by the connection of additional generators and/or disconnection of consumers or negative control power by the disconnection of generators and/or additional connection of consumers. There is a general need for cost-effective and efficient provision of these supplies of control power, where the requirements for the capacities to be maintained and the dynamic range of the control power sources or sinks can vary according to the characteristics of the electrical grid.

In Europe, for example, there is a code of practice (UCTE Handbook), which describes three different categories of control power. In it, the respective requirements for the types of control power are defined. Among the ways in which the types of control power differ are the requirements for the dynamic range and the duration for which power is to be delivered. They are also used differently with regard to the boundary conditions. Primary control power (PCP) is to be delivered Europe-wide by all of the sources involved independently of the place of origin of the disturbance, this being substantially in proportion to the frequency deviation at the given time. The absolute maximum power has to be delivered when there are frequency deviations of minus 200 mHz and below (in absolute terms), the absolute minimum power has to be delivered when there are frequency deviations of plus 200 mHz and above. With regard to the dynamic range, it is required that, from the non-operative state, the respective maximum power (in terms of the absolute value) must be provided within 30 seconds. By contrast, secondary control power (SCP) and minute reserve power (MRP) are to be delivered in the balance areas in which the disturbance has occurred. Their task is to compensate as quickly as possible for the disturbance and thus ensure that the grid frequency is restored as quickly as possible to the desired range, preferably at the latest after 15 minutes. With regard to the dynamic range, lower requirements are stipulated for the SCP and MRP (5 minutes and 15 minutes, respectively, before full power is delivered after activation); at the same time, these power outputs must also be provided over longer time periods than primary control power.

In the electrical grids operated heretofore, a large part of the control energy is provided by conventional power stations, in particular coal and nuclear power stations. This results in two fundamental problems. Firstly, the conventional power stations providing control power are not operated at full load, and consequently maximum levels of efficiency, but slightly below, in order to be able when required to provide positive control power, possibly over a theoretically unlimited time period. Secondly, with increasing expansion and increasingly preferred use of renewable energy sources, there are fewer and fewer conventional power stations in operation, which however is often the basic prerequisite for delivering supplies of control power.

For this reason, approaches have been developed for using energy stores to an increased extent in order to store negative control energy and to provide it as positive control energy as necessary.

The use of hydro pumped-storage stations for delivering control power is prior art. In Europe, the various types of control power are delivered by pumped-storage stations. Hydro pumped-storage stations are however also repeatedly cited as currently the most cost-effective technology for storing and retrieving forms of renewable energy, to allow energy supply and demand to be better adapted to one another in terms of time. The potential for the expansion of storage capacities is a controversial subject of discussion—in particular in Norway—since use requires considerable capacities in power lines to be approved and installed. Consequently, use for energy load management is in competition with the provision of control power.

Against this background, in the area of primary control power many plans for also using other storage technologies, such as for example flywheel mass and battery stores, for the provision of control power have recently been investigated and described.

US 2006/122738 A1 discloses an energy management system which comprises an energy generator and an energy store, the energy store being able to be charged by the energy generator. This is intended to enable an energy generator that does not ensure uniform energy generation in normal operation, such as for example the increasingly favoured renewable energy sources such as wind-power or photovoltaic power stations, to output their energy more uniformly into the electrical grid. A disadvantage of this is that, although a single power station can be stabilized in this way, all other disturbances and fluctuations of the electrical grid cannot be counterbalanced, or can be counterbalanced only to a very limited extent.

It is known from WO 2010 042 190 A2 and JP 2008 178 215 A to use energy stores for providing positive and negative control power. If the grid frequency leaves a range around the desired grid frequency, either energy is provided from the energy store or energy is taken up in the energy store, in order to regulate the grid frequency. DE 10 2008 046 747 A1 also proposes operating an energy store in an island electrical grid in such a way that the energy store is used to compensate for consumption peaks and consumption minima. A disadvantage of this is that the energy stores do not have the necessary capacity to compensate for a lengthy disturbance or a number of successive disturbances in the same direction with regard to the frequency deviation.

In general, the electrical grids are stabilized by technologies which are assigned to different classes with regard to the total capacity and the dynamic range of the production of power. In this regard, in the European interconnected grid of the UCTE (Union for the Co-ordination of Transmission of Electricity), for example, there is division into primary control power (PCP), secondary control power (SCP) and minute reserve (MR).

In the article “Optimizing a Battery Energy Storage System for Primary Frequency Control” by Oudalov et al., in IEEE Transactions on Power Systems, Vol. 22, No. 3, August 2007, the dependence of the capacity of a rechargeable battery on technical and operational boundary conditions is determined in order that said battery can provide primary control power according to the European standards (UCTE Handbook). It is evident that the store is unavoidably charged or discharged repeatedly at different time intervals in the long term on account of the storing and outputting losses. In this respect, the authors propose the periods of time in which the frequency is in the dead band (i.e. in the frequency range in which no control power is to be produced). Nevertheless, in the short term or temporarily the situation can occur that the store is overcharged. The authors propose for such cases the (limited) use of loss-generating resistors which in the extreme case take up the complete negative nominal control power, that is to say have to be designed for that. Besides the additional capital expenditure requirement for the resistors and the cooling thereof, this leads, however, as already mentioned by the authors themselves to more or less undesirable energy degradation, wherein the waste heat that arises generally cannot be utilized. The authors demonstrate that reduced recourse to loss generation is possible only by means of a higher storage capacity, associated with higher capital expenditure costs.

The price for the provision of control power is crucially based on how quickly the control power can be provided after a request, that is to say after a frequency deviation outside the tolerance. In the case of PCP and SCP, payment is made just for keeping the energy available on standby. In the case of SCP and MR, the operational performance is also remunerated.

In the area of secondary control power provision, the various requirements for the dynamic range of the delivery of power (commissioning and decommissioning) of the sources (or of the pools of sources) are explained below for the example of the European interconnected grid of the UCTE.

1. The prequalifiable secondary control power (SC power, SCP or else nominal power for short) results from the change in power (any direction of control) that is activated and measured within 5 minutes.
2. Brief overshooting of a maximum of 10% above the secondary control power desired value is admissible. Brief overshooting up to 5 MW is permissible in any case.
3. In the case of secondary control power pools, a reaction of the pool must be measurable for the transmission grid operator after 30 seconds at the latest.

The remunerations for the provision of secondary control power are made up of a system charge for keeping the secondary control power on standby and a supply charge for the energy actually delivered in the course of the provision of secondary control power.

Such stipulations, in particular concerning groups of energy generators, can be seen in the Forum of Grid Technology/Grid Operation of the VDE (FNN) “TransmissionCode 2007”, of November 2009. Relevant in this respect in particular is Appendix D2 for the requirements of SCP pools, in which it is also described by which methods a master control technique can be operated by a supplier of SCP. This document discloses operating a plurality of technical units, such as hydraulic and thermal power stations, jointly as a pool for providing control power.

Rechargeable batteries can take up or output energy very rapidly, as a result of which they are suitable, in principle, for providing PCP. However, a disadvantage of this is that very large capacities of the rechargeable batteries have to be provided in order also to be able to supply the power over a lengthy time period or repeatedly. However, rechargeable batteries with a very great capacity are also very expensive.

When using power stations or consumers, such as electrolysis factories, for the provision of control power, there is the problem that they cannot be run up quickly enough to provide for MR or for SCP in case of need at the speed required. They are therefore usually not operated at full load and are operated at a higher power only in case of need, which is detrimental to the efficiency of the power station or the consumer. Moreover, in these cases only a small proportion of the maximum power that can be generated or consumed can be prequalified as nominal power. As an alternative thereto, energy generators or energy consumers can be derated in order to attain in the predefined periods of time at least a specific power which can then also be ensured as prequalification power for the power station or the consumer as control power source.

What is disadvantageous here, therefore, is that currently there is no possibility of operating energy generators or energy consumers for providing control power as efficiently as possible just like during operation for providing power without control and thus with the best possible efficiency, and also over a relatively long time, in order to make available control power for stabilizing the electrical grid. Derating is uneconomic in any case.

The object of the invention is therefore to overcome the disadvantages of the prior art. In particular, the intention is to find a possibility of providing control power in conjunction with an efficient energy yield of the control power supplier. At the same time, the intention is to prevent energy from being unnecessarily given away to the grid operator or drawn from the electrical grid and to ensure a high efficiency when generating or consuming the energy. Furthermore, the intention is for control power to be able to be provided as rapidly as possible.

A further object of the invention can be seen in the fact that, particularly when using galvanic elements, such as rechargeable batteries, the intention is for the capacity or the maximum energy content of the energy store to be as low as possible for providing the required control power.

The objects of the invention are achieved by virtue of the fact that an energy generator and/or an energy consumer is operated together with an energy store connected to the electrical grid for providing the control power, wherein the energy store starting from a first point in time outputs to the electrical grid at least the difference between the power provided by the energy generator and a nominal power or takes up from the electrical grid at least the difference between the power taken up by the energy consumer and a nominal power and the energy store provides at least this difference between the nominal power and the power provided by the energy generator or the power taken up by the energy consumer until the power of the energy generator or of the energy consumer reaches the nominal power at a second point in time.

In the present case, the nominal power should be understood to mean the power with which the control power source which is operated by a method according to the invention is prequalified. Advantageously, according to the invention, this nominal power can be at least in the region of the maximum power of the energy generator or of the energy consumer. The capacity of the energy store has to be chosen merely to be high enough for this purpose.

The control power is output to the electrical grid (positive control power) or taken up from the electrical grid (negative control power). The advantage of methods according to the invention can be seen, inter alia, in the fact that the energy store makes it possible to keep available a higher prequalifiable nominal power as control power source.

This can take place according to the invention and particularly preferably also as often as desired in succession by virtue of the energy store being repeatedly charged or discharged anew after the second point in time, in order to have the suitable state of charge again in a second cycle. The suitable state of charge is charged if the energy store is combined only with an energy generator, discharged if the energy store is combined only with an energy consumer, and approximately half charged if the energy store is combined with an energy generator and an energy consumer. The state of charge corresponds, in particular in the case of rechargeable batteries as energy store, to the state of charge (SoC) or to the state of energy (SoE). The terms state of charge and charge state should be regarded as equivalent according to the invention.

It is particularly preferred if, in this case, the invention provides for the energy store starting from a third point in time to take up energy of the energy generator, while the power of the energy generator is reduced, and/or for the energy store starting from the third point in time to provide energy for the energy consumer, while the power of the energy consumer is reduced.

This has the advantage that the energy store is charged or discharged with the energy which cannot be sold as control power. As a result, the energy store is additionally put into the suitable state of charge for the next control cycle.

Furthermore, it can be provided that the energy store used is a flywheel, a heat accumulator, a hydrogen generator and store with fuel cell, a natural gas generator with gas power station, a pumped-storage power station, a compressed-air energy storage power station, a superconducting magnetic energy store, a redox flow element and/or a galvanic element, preferably a rechargeable battery and/or a battery storage power station, particularly preferably a lithium-ion rechargeable battery. The heat store must be operated together with a device for producing electricity from the stored thermal energy.

Rechargeable batteries in particular are particularly suitable for methods according to the invention, on account of their rapid reaction time, that is to say the rate at which the power can be increased or reduced.

The rechargeable batteries include, in particular, lead-acid rechargeable batteries, sodium-nickel chloride rechargeable batteries, sodium-sulphur rechargeable batteries, nickel-iron rechargeable batteries, nickel-cadmium rechargeable batteries, nickel-metal hydride rechargeable batteries, nickel-hydrogen rechargeable batteries, nickel-zinc rechargeable batteries, tin-sulphur-lithium-ion rechargeable batteries, sodium-ion rechargeable batteries and potassium-ion rechargeable batteries.

Of these, rechargeable batteries that have a high efficiency and a high operational and calendrical lifetime are preferred. As a particularly preferred embodiment of the invention, lithium-polymer rechargeable batteries, lithium-titanate rechargeable batteries, lithium-manganese rechargeable batteries, lithium-iron-phosphate rechargeable batteries, lithium-iron-manganese-phosphate rechargeable batteries, lithium-iron-yttrium-phosphate rechargeable batteries, lithium-air rechargeable batteries, lithium-sulphur rechargeable batteries and/or tin-sulphur-lithium-ion rechargeable batteries are used as lithium-ion rechargeable batteries.

Provision can also be made for making it possible to store in the energy store an energy of at least 4 kWh, preferably of at least 10 kWh, particularly preferably at least 50 kWh, especially preferably 250 kWh.

The capacity of electrochemical energy stores may in this case be at least 40 Ah, preferably approximately 100 Ah. With the use of stores based on electrochemical elements, in particular rechargeable batteries, this store can advantageously be operated with a voltage of at least 1 V, preferably at least 10 V, and particularly preferably at least 100 V.

The ratio of the nominal power of the energy store to the maximum power of the control energy supplier can preferably be in the range of 1:10 000 to 10:1, particularly preferably in the range of 1:1000 to 1:1.

According to the invention it can be provided that the energy store consists of a pool of a plurality of energy stores. In this case, the different energy stores can also be arranged at different locations in the electrical grid. By way of example, the energy store can comprise a multiplicity of rechargeable batteries in electric automobiles, for example, which are connected as a pool when they are connected to a charging station and thus to the electrical grid.

Furthermore, it can be provided that the power of the energy store is increased over a period of time of at least 0.5 s before the first point in time until the first point in time, preferably over a period of time of at least 2 s, particularly preferably over a period of time of at least 30 s.

These slower ramps ensure that excitations of undesired disturbances or oscillations in the electrical grid or at the connected consumers and generators as a result of an excessively steep power gradient to not occur.

According to the invention it can also be provided that the energy generator used is a power station, preferably a coal power station, gas power station or a hydroelectric power station, and/or the energy consumer used is a factory for manufacturing a substance, in particular an electrolysis factory or a metal factory, preferably an aluminium factory or a steel factory.

Such energy generators and energy consumers are well suited for the provision of supplies of control power in the relatively long term. According to the invention, their inertia can be balanced out well by energy stores.

In accordance with a further embodiment of the invention, it can be provided that the energy store at least partly takes up and/or outputs an overshoot energy, the energy store taking up and/or outputting preferably at least 25%, particularly preferably at least 50%, of said overshoot energy, wherein the overshoot energy is generated in the event of the power of the energy generator overshooting beyond the nominal power and/or it is consumed in the event of the power of the energy consumer overshooting beyond the nominal power, in particular in the case of changes in the power to be provided.

This ensures that the wishes of the customer, that is to say of the grid operator, for a foreseeable and defined control power can be fulfilled, and that no control oscillations are generated in the electrical grid. Moreover, the energy that is taken up or output in this way can be utilized in order to improve the state of charge of the energy store, that is to say to change it in the desired direction.

Furthermore, it can be provided that the nominal power of the energy generator together with the energy store and/or the nominal power of the energy consumer together with the energy store are/is reached by the method within 15 minutes, preferably within 5 minutes, particularly preferably within 30 seconds, at least to the extent of 95%.

With these parameters, control power sources operated in this way can be used efficiently and with better efficiency as secondary control power sources or even as primary control power sources. Moreover, a higher nominal power can thus also be prequalified.

According to the invention it can also be provided that the grid frequency of the electrical grid is measured and control power is output to the electrical grid or taken up from the electrical grid in the event of a deviation from a desired value or a deviation from a tolerance around a desired value and/or the control power is reduced in the event of the grid frequency returning to the desired value or within the tolerance.

This enables the grid frequency to be controlled in an automated manner.

In accordance with a further embodiment of the invention, it can be provided that the energy store in the event of a reduction in the power of the energy generator is charged to the extent of at least 50%, in particular is substantially completely charged, and/or the energy store in the event of a reduction in the power of the energy consumer is discharged to less than 50%, and is substantially completely discharged.

These embodiments of the invention are particularly suitable if the energy store is operated only with an energy generator or only with an energy consumer, since the charge of the energy store is well prepared at the beginning of the method according to the invention, that is to say for the next cycle.

As an alternative thereto, it can be provided that the energy store is operated together with an energy generator and an energy consumer and the energy store in the event of a reduction in the power of the energy generator is charged approximately to the extent of half, preferably between 25% and 75%, particularly preferably between 40% and 60%, especially preferably between 45% and 55%, or the energy store in the event of a reduction in the power of the energy consumer is discharged approximately to the extent of half, preferably between 25% and 75%, particularly preferably between 40% and 60%, especially preferably between 45% and 55%.

The suitable state of charge of the energy store at the beginning of a method according to the invention is approximately 50%, if both an energy generator and an energy consumer are operated with the energy store. This is achieved by means of these measures for the subsequent cycles.

It can also be provided that the power of the energy consumer that is output to the electrical grid or the power of the energy generator that is taken up from the electrical grid, after the first point in time, is measured at a plurality of points in time, in particular continuously, and the difference with respect to the nominal power is calculated at a plurality of points in time, preferably continuously, wherein power of the energy store that is output or taken up is set depending on this difference, preferably the power is set to be exactly equal to this difference or somewhat greater.

This ensures a control power that is fed uniformly into the electrical grid. Moreover, as little energy as possible is wasted as a result.

It can also be provided that the energy generator and/or the energy consumer have/has a maximum power of at least 1 MW, preferably at least 10 MW, particularly preferably at least 100 MW.

A further embodiment of the method according to the invention can provide for the capacity of the energy store to be chosen to be at least high enough that in the energy store it is possible to store the energy required for bridging the nominal power to be provided starting from the first point in time until the nominal power is reached by the energy generator and/or the energy consumer at the second point in time.

Coordinating the capacity of the energy store with the performance (the maximum rise in power) of the energy generator and/or of the energy consumer has the advantage that the energy store can be dimensioned and constructed in a manner as small as possible and thus as cost-effectively as possible.

The object of the invention is achieved with regard to a device by virtue of the fact that the device comprises a controller, an energy store and an energy generator and/or an energy consumer, wherein the device is connected to an electrical grid, the controller is connected to the energy store and the energy consumer and/or the energy generator, and controls the control power generated and/or taken up.

According to the invention, in the present case, a controller is understood to mean a simple open-loop controller. In this case, it should be noted that any closed-loop controller encompasses open-loop control since a closed-loop controller carries out control over and above open-loop control in a manner dependent on a difference between an actual value and a desired value. Preferably, therefore, the controller is embodied as a closed-loop controller, in particular with regard to the state of charge. Particularly preferably, the controller is a control system.

In this case, it can be provided that the device comprises a frequency measuring unit for measuring the grid frequency of the electrical grid and a memory, wherein at least one limit value of the grid frequency is stored in the memory, wherein the controller is designed to compare the grid frequency with the at least one limit value and to control the power of the energy store and of the energy consumer and/or of the energy generator depending on the comparison.

Finally, it can also be provided that the capacity of the energy store is at least high enough that in the energy store it is possible to store the energy required for bridging the nominal power to be provided starting from the first point in time until the nominal power is reached by the energy generator and/or the energy consumer at the second point in time, the capacity of the energy store preferably being high enough that in the energy store it is possible to store 99% to 150% of the energy required for this purpose, particularly preferably 100% to 120%, especially preferably 100% to 110%.

The nominal power of the device for providing control power is that power which can be achieved within a specific time. Mention is also made here of the prequalifiable power, since this meets the criteria of the customer, that is to say the grid operator.

The invention is based on the surprising insight that by combining an energy store with at least one conventional control power source, it is possible to improve the latter with regard to its properties as a control power source. Inter alia, a minute reserve can be converted into a secondary control power source or even into a primary control power source. In this case, the energy store can be used for increasing the rise in power, but also for taking up undesired overshoots beyond the agreed nominal power.

One insight that is important for achieving the object consists, therefore, in the fact that the abovementioned restrictions for the example of the European interconnected grid of the UCTE are complied with by means of a suitable pooling of battery stores (rechargeable batteries) with conventional SC sources.

Specific and particularly preferred embodiments of the solution approaches consist in the fact that the energy store is a rechargeable battery or a battery store that is simultaneously used for producing primary control power. In general, such a store still has reserves both with regard to the powers and with regard to the energies in normal operation. In a further specific embodiment, the energy taken up into the store in the case of negative SC power can be disposed of on the spot market, if the conditions there are advantageous.

In preferred embodiments of the invention, a number of energy stores are pooled and operated by a procedure according to the invention. The size of the energy stores within the pool may vary. In one particularly preferred embodiment, when using tolerances, in particular when choosing the bandwidth in the dead band, for the various energy stores of a pool, the change from one parameter setting to another is not performed synchronously but specifically at different times, in order to keep any disturbances in the grid as small as possible or at least to a tolerable level.

The tolerance with regard to the absolute value of the control power provided and the tolerance when determining the frequency deviation, etc. should be understood, according to the invention, to mean that certain deviations between an ideal desired power and the control power actually produced are accepted by the grid operator, on account of technical boundary conditions, such as the measurement accuracy when determining the control power produced or the grid frequency. The tolerance can be granted by the grid operator, but could also conform to a legal predefined stipulation.

In a further preferred embodiment, the tolerances used in the various procedures, in particular the choice of the bandwidth in the dead band, vary according to the time of day, the day of the week or the time of year. By way of example, tolerances can be defined more narrowly in a period of from 5 min before to 5 min after the hour change. This is owing to the fact that very rapid frequency changes often take place here. It may be in the interests of the transmission grid operators for there to be lower tolerances here and thus for the control energy to be provided more certainly in the sense of more rigorously.

According to a further embodiment, it may be provided within the stipulations for delivering control power that in particular more energy is taken up from the grid by the energy store than is fed in. This may take place because, according to the regulations including the previously set out procedure, preferably a very large amount of negative control power is provided, whereas, according to the regulations including the previously set out procedure, preferably only the minimum assured amount of positive control power is delivered. Preferably, on average at least 0.1% more energy is taken from the grid than is fed in, in particular at least 0.2%, preferably at least 0.5%, particularly preferably at least 1.0%, especially preferably 5%, these values being related to an average that is measured over a time period of at least 15 minutes, preferably at least 4 hours, particularly preferably at least 24 hours and especially preferably at least 7 days, and relate to the energy fed in.

This may involve using the previously set out delivery of control power in order to draw a maximum of energy from the grid, the maximum possible negative control power being provided, whereas only a minimum of positive control power is delivered.

In the embodiments regarding the preferred, and especially maximum, energy take-up, the energies thereby drawn from the grid can be sold through the previously described energy trading, this preferably taking place at times at which a price that is as high as possible can be achieved. Forecasts of the price development that are based on historical data may be used for this purpose.

Furthermore, the state of charge of the energy store at the time of a planned sale of energy may be preferably at least 70%, particularly preferably at least 80% and particularly preferably at least 90%, of the storage capacity, the state of charge after the sale preferably being at most 80%, in particular at most 70% and particularly preferably at most 60%, of the storage capacity.

Exemplary embodiments of the invention are explained below with reference to five schematically illustrated figures, but without restricting the invention here. In detail:

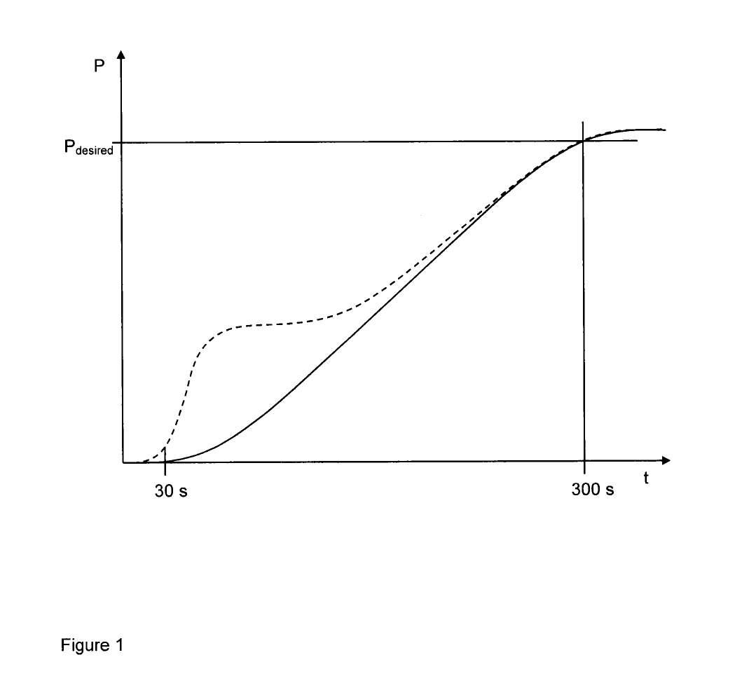

FIG. 1: shows a schematic P-t diagram of a conventional secondary control power source and of a conventional pool as secondary control power source;

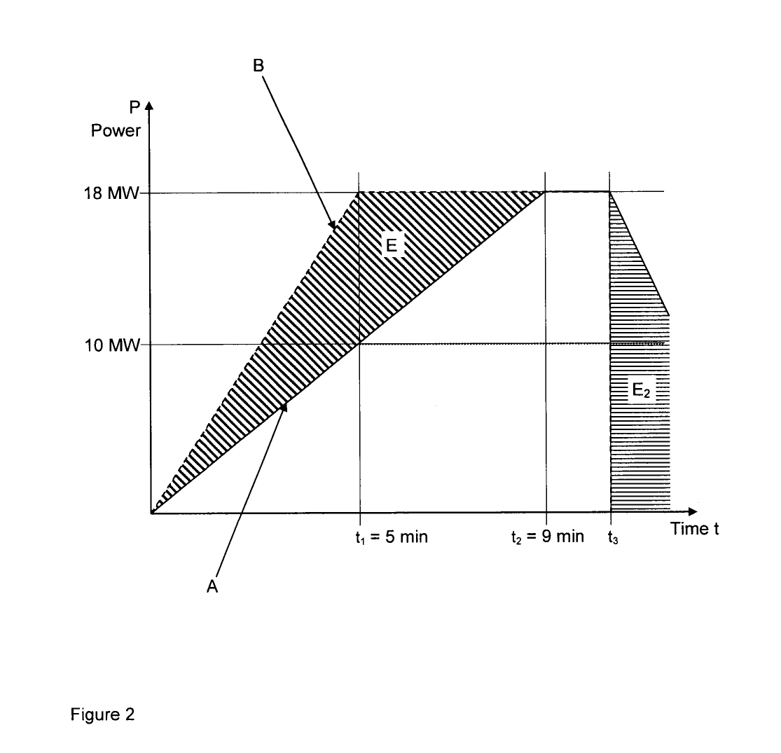

FIG. 2: shows a schematic P-t diagram of a control power source operated by a method according to the invention;

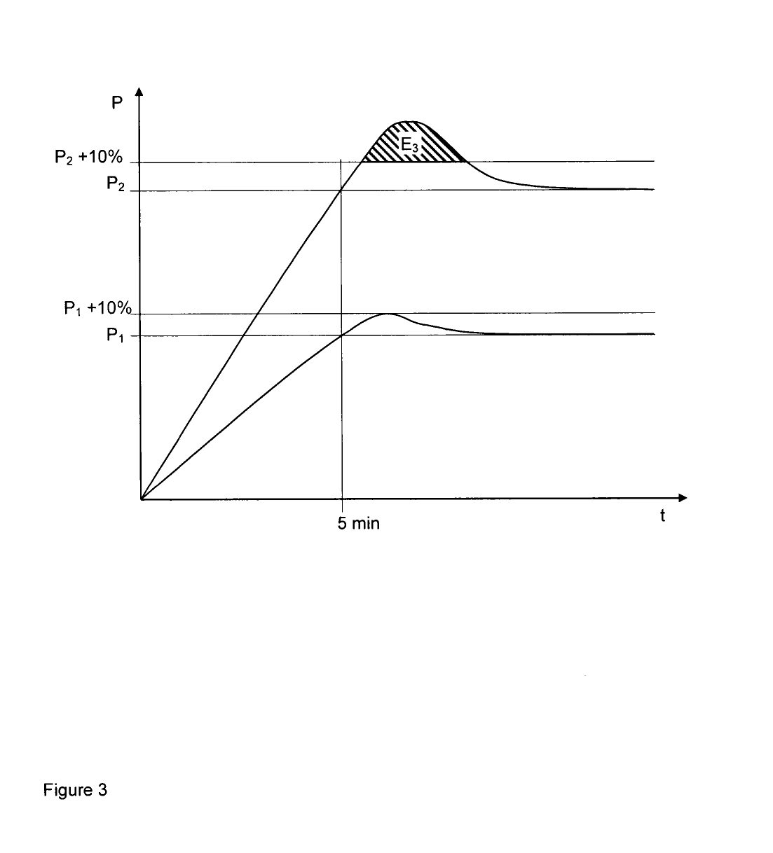

FIG. 3: shows a second schematic P-t diagram of a control power source operated by a method according to the invention and of a conventional control power source;

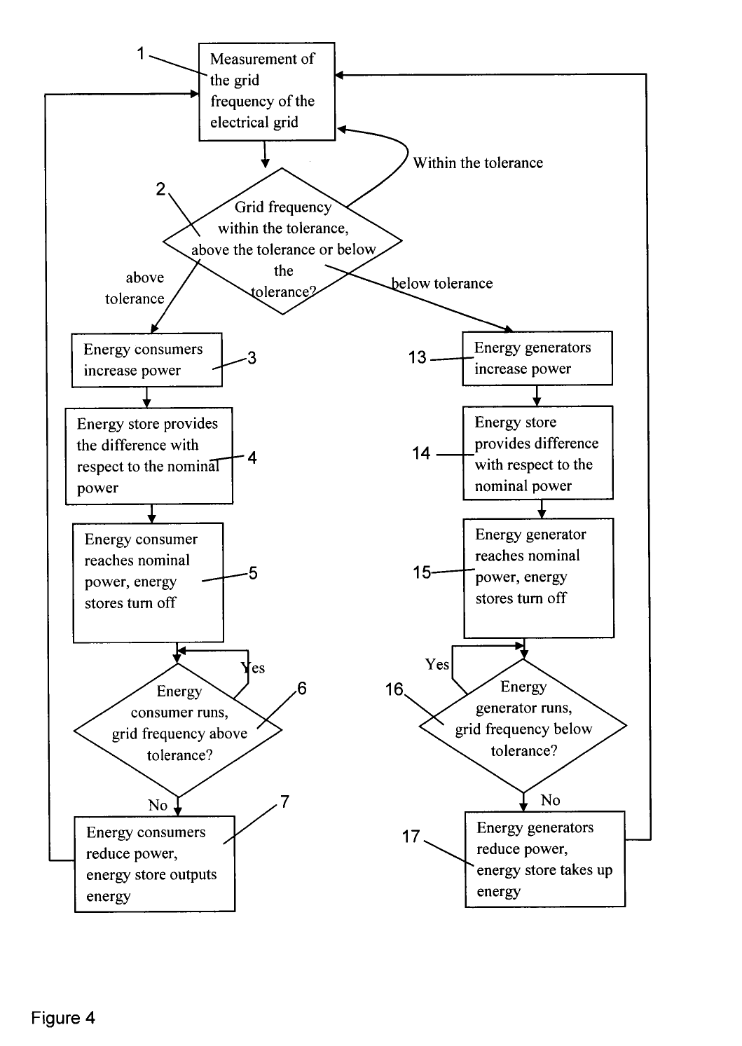

FIG. 4: shows a flow chart for a method according to the invention; and

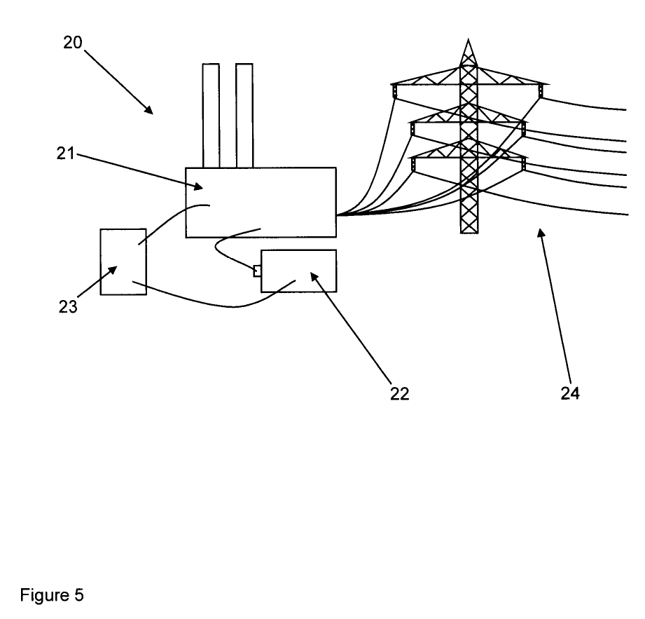

FIG. 5: shows a schematic illustration of a device according to the invention for providing control power.

FIG. 1 shows a diagram of the power (P) against time (t) of a conventional individual secondary control power source (solid line) and a pool as secondary control power source (dashed line), which comprises a hydroelectric power station and a thermal power station (for example a nuclear power station). The hydraulic hydroelectric power station makes a contribution to the control power right at the beginning. The energy additionally mustered by the hydroelectric power station can additionally be sold and ensures that a reaction of the pool as secondary control power source is rapidly discernible to the customer, that is to say the grid operator.

The requirements imposed above in the context of the example of the European interconnected grid of the UCTE lead to restrictions of the marketable potential for numerous market participants. This is owing to the fact, for example, that the marketable power is limited by a low power gradient, or a higher power can be produced within 5 minutes, in principle, but they lead to impermissibly high overshoots above the nominal power (P_{desired}) in a manner governed by control engineering.

Even with a given and marketed control power, a considerable potential often remains unused. This concerns, in particular, the energy produced or the operating revenues. After the secondary control (SC) power (SCP) has been called up, the dynamic range of the SC technologies or of the technical units in a pool for providing SCP determines how many operating revenues can be obtained. In the diagram according to FIG. 1, for example, the potential operating revenue which corresponds to the area above the dashed curve remains unused on account of technical limitations.

In order to improve the economic viability of SC technologies, therefore, there is a need for technical alternatives in order to cancel or at least significantly reduce the limitations of conventional SC technologies.

In the start-up phase in daily operation, according to the invention an energy store can be used to close the difference between power requirement (desired value) and present power production and thus to obtain additional operating revenues. In the diagram according to FIG. 1 as already shown, that would mean that the energy associated with the area above the curve having the solid line and below the straight line of the nominal power (P_{desired}) could additionally be marketed and additional revenues would be obtained as a result. In one specific embodiment, the decision as to whether this energy is additionally produced could be made dependent on the present kilowatt-hour rates or on the present state of charge of the energy store.

In detail, the following procedure can be adopted here according to the invention. If the dynamic range of the production of power in conventional SC technology is restricted, then an energy store is used for support. This is depicted in a schematic power-time diagram according to FIG. 2. Conventionally, only 10 MW could be prequalified here owing to the restricted power gradient, even though even higher powers could be produced after more than 5 minutes. In a pool with a suitable battery store (rechargeable battery), the prequalifiable power can be increased to 18 MW. In this case, the battery store closes the corresponding gap until 9 minutes have elapsed. The high power in conjunction with comparatively short power production time fits very well with specific storage technologies such as, for example, lithium-ion battery technology, but also flywheel or gas pressure storage power stations.

The solid line A shows the maximum rise in power of a conventional power station, such as a coal power station or a gas power station, for example. After 9 minutes, the power station reaches its maximum power of 18 MW. This is too slow, however, for providing SCP. The provision of SCP thus requires that the prequalifiable power of an SC power source should already be reached after 5 minutes. Accordingly, the conventional power station can provide only a prequalifiable power of 10 MW, or is prequalifiable only for an SC power of 10 MW.

In a method according to the invention, the conventional power station is now combined with a rechargeable battery. As soon as a request for the provision of SC power is received, not only is the conventional power station started up, but the rechargeable battery is connected. The power of the rechargeable battery is increased until the point in time t₁=5 minutes. At said point in time t₁, the rechargeable battery supplies a power of 8 MW, that is to say exactly the difference between the power produced by the conventional power station owing to its maximum temporal gradient after 5 minutes and the maximum power of the conventional power station.

The device according to the invention, namely the combination of a conventional power station and a rechargeable battery and also a controller for implementing such a method according to the invention, is thus able after just 5 minutes to muster a power of 18 MW, that is to say the maximum power of the conventional power station. As a result, the device is prequalifiable for providing SC power to 18 MW.

The power of the rechargeable battery can be continuously reduced starting from the point in time t₁, specifically to the extent to which the power of the conventional power station increases. For this purpose, a controller can be provided, which measures the missing power of the conventional power station with respect to the maximum power thereof and provides this power from the rechargeable battery. The power of the rechargeable battery is therefore reduced to zero by the point in time t₂, since the entire control power can be mustered by the conventional power station starting from this point in time t₂.

During the provision of the SC power, therefore, the rechargeable battery has to muster an energy E corresponding to the diagonally hatched area in FIG. 2. The energy E is equal to the integral of the power of the rechargeable battery over time, from which the integral of the power of the conventional power station over time is subtracted. The capacity of the rechargeable battery should therefore be chosen to be at least approximately high enough that the energy E can be taken up or output. If only a prequalifiable power of the control power source according to the invention is offered which is less than the maximum power of the energy generator/power station and/or of the energy consumer, then the capacity of the rechargeable battery can be chosen to be correspondingly smaller.

If control power is no longer required starting from a point in time t₃, the conventional power station usually cannot simply be switched off, rather the power is reduced to zero over a period of time. The energy E₂ provided by the conventional power station in this period of time starting from the point in time t₃, identified by the horizontally hatched area in FIG. 2, need no longer be fed into the grid, but rather can instead be used according to the invention for charging or recharging the rechargeable battery.

The explained method according to the invention and the discussed device according to the invention therefore make it possible to provide an optimum control power profile, represented by the dashed curve in FIG. 2. The weaknesses of conventional methods, represented by the solid line in FIG. 2, have been able to be overcome according to the invention.

The principle discussed in this exemplary embodiment with reference to FIG. 2 can readily be applied to an energy consumer and a rechargeable battery or to an energy consumer and some other energy store. Instead of supplying a power of a maximum of 18 MW, provision can also be made, for example, for a maximum power of 18 MW to be consumed by a factory (energy consumer). The factory can produce for example methane or ethane or else hydrogen. Until the maximum power 18 MW of the energy consumer is reached after 9 minutes at the point in time t₂, the energy store, for example a flywheel, from which energy is tapped electrically, can take up the missing power, that is to say that the energy E is stored in the energy store between the first point in time t₁ and the second point in time t₂. As a result of this measure, the device according to the invention comprising the energy consumer and the energy store is prequalifiable not just to 10 MW, but to 18 MW.

In this case, it is particularly advantageous if the energy store can supply energy very rapidly and is particularly fast in its reaction. Therefore, rechargeable batteries and to a certain extent flywheels, too, are particularly well suited as energy stores, while pumped-storage power stations or, in particular, gas generators with a store and a gas power station as energy stores are not as well suited to implementing methods according to the invention.

The device according to the invention can also comprise an energy consumer, an energy store and an energy generator and in this case implement a method according to the invention wherein both positive, and negative control power can be provided and all three components are used.

If an overshoot has a limiting effect in the case of the increase or reduction of power, the energy store can be used to limit the overshoot by targeted, that is to say opposite, power production. This is depicted schematically in the diagram according to FIG. 3. If, for example, only an overshoot of the nominal power P₂ of a control power source by a maximum of 10% of the prequalified power P₂ is permitted by the grid operator, the energy store can be used to take up any energy exceeding that or, for the case where an overshoot occurs in the event of negative control power being provided, to provide said energy.

FIG. 3 shows how a conventional energy generator or energy consumer for providing control power has to be operated (lower curve) if, in the case of a maximum increase in power, it overshot (upper curve) by an excessively high amount (more than 10%) above the prequalified nominal power P₂. In the case of a maximum increase in power, although a higher prequalifiable power P₂ could be achieved, in principle, such an increase in power cannot be offered as a result of the excessively high overshooting. The lower curve illustrates with what increase in power the conventional energy generator or energy consumer can still be operated in order to limit the overshoot above the prequalified nominal power P₁ to 10%. As a result, however, only a lower prequalifiable nominal power P₁ is possible within the prescribed control time of 5 minutes. It is only with the aid of the energy store, which takes up or outputs an overshoot energy E₃ that is generated or consumed in the case of an excessively high power, that it is possible to operate the energy generator or energy consumer with a maximum increase in power, without the power provided overshooting by more than 10% above the maximum control power P₂. The overshoot energy E₃ is illustrated as a diagonally hatched area in the diagram according to FIG. 3. As a result, it is possible to offer a higher prequalified power P₂ with the same energy consumer or energy generator than without the combination with the energy store and without the method according to the invention, in the case of which only a lower prequalified power P₁ could be offered.

In contrast to what is shown in FIG. 3, it may also be preferred for any excess control energy to be taken up or output by the energy store, since the energy contributions up to 10% above the prequalified power do not have to be remunerated or paid for.

Likewise, however it can also be provided that the excess power output by the energy generator in the range of 0% to 10% of the prequalified power is taken up by the energy store, or the excess power taken up by the energy consumer in the range of 0% to 10% of the prequalified power is output by the energy store, only if this appears to be expedient from the standpoint of the state of charge of the energy store. In other words if, by way of example, the energy store is already charged to the extent of more than 50% or two thirds charged, it may be expedient to take up the excess energy of an energy generator only if the latter produces a power of more the 10% above the prequalified power P₂. This takes place in order to keep the state of charge of the energy store in a desired state suitable for the subsequent control cycles.

The energy store, which is preferably a rechargeable battery, makes it possible in this way for the conventional SC technology to be prequalified with a higher power than if it were operated by itself.

Furthermore, the overshoot energy E₃ provided or consumed in the event of overshooting cannot be sold to the grid operator since this power cannot be provided in a sustained manner. Instead, it is taken up into the energy store or provided by the energy store, such that the overshoot energy E₃ can remain with the operator of the control power installation, or need not be purchased from the electrical grid.

Moreover, precisely if, in a method according to the invention, as discussed with regard to FIG. 2, the energy store has just been drained or replenished, opposite charging or discharging of the energy store in the event of subsequent overshooting is welcome in order to keep the state of charge of the energy store in a desired range.

In the start-up phase in daily operation, the energy store can be used to close the difference between power requirement (desired value) and present power production and thus to obtain additional operating revenues. In the diagram already shown, that would mean that the energy associated with the area above the solid curve according to FIG. 1 could additionally be marketed and additional revenues would be obtained as a result. In one specific embodiment, the decision as to whether this energy is additionally produced could be made dependent on the present kilowatt-hour rates or on the present state of charge of the battery store. In this case, the state of charge can be determined on the basis of the SOC or the state of energy of the energy store.

FIG. 4 shows a flow chart for a method according to the invention. An energy store, an energy generator and an energy consumer are used in the method. In step 1, the grid frequency of the electrical grid is measured. In decision step 2, a check is subsequently made to determine whether the grid frequency is within a desired range on the part of the grid operator (within a tolerance) or above that or below that. As an alternative thereto, it is also possible to react to a request on the part of the grid operator. The grid operator would then indicate whether positive or negative control power is required by said grid operator.

If the grid frequency is within the desired range, the method continues with step 1. If the grid frequency is above the desired range, energy has to be drawn from the electrical grid. For this purpose, in step 3, the energy consumer is started and the power of the energy consumer is increased. Depending on what is agreed with the grid operator, in the next step 4, the energy store can take up the difference power with respect to the prequalified power at the agreed point in time t₁, by means of the energy store being charged. The pool comprising energy consumer and energy store then supplies the prequalified nominal control power, that is to say that the prequalified power is drawn from the electrical grid. If the pool is prequalified as a primary control power source, for example, then the nominal power has to be consumed already as of t₁=30 seconds. By contrast, if the pool is prequalified as a secondary control power source, for example, then the nominal power has to be consumed only as of t₁=5 minutes. Particularly with the use of rechargeable batteries, the control power can be taken up very rapidly, that is to say that the power can be increased very rapidly.

During step 4, the power of the energy consumer will rise further starting from the point in time t₁. To the extent to which the power of the energy consumer rises, the power taken up by the energy store can be reduced. In step 5, at the point in time t₂ the energy consumer finally reaches its full power capability, which is also prequalified as nominal power. The energy store can then be switched off, since the entire power can be taken up by the energy consumer.

In decision step 6, a check is made, finally, to determine whether the grid frequency is still above the desired range. If that is so, the energy consumer continues to run all the time and takes up energy. If that is not the case, the power of the energy consumer is reduced starting from the point in time t₃ in step 7. At the same time, in step 7, the power for the energy consumer is supplied by the energy store that has been charged in steps 3 and 4, and the charge of the energy store is reduced again in this case.

Afterwards, the grid frequency is measured again in step 1. According to the invention, the measurement of the grid frequency can also be carried out in parallel with steps 3, 4, 5 and 7, the power of the energy consumer being increased whenever the grid frequency is above the desired range.

Steps 1 to 7 together already yield a method according to the invention for an energy store and an energy consumer, wherein step 2 only makes a decision as to whether or not the grid frequency is below the desired range.

If the grid frequency is below the desired range in decision step 2, the method continues with step 13. In this step 13, the power of an energy generator, such as a coal power station, for example, is increased. At the latest starting from the point in time t₁ at which the nominal power has to be provided, the energy store supplies the missing power of the energy generator in step 14. The power of the energy generator will rise and the power of the energy store is accordingly reduced until finally, in step 15, at the point in time t₂, the energy generator reaches the nominal power and the energy store can be switched off.

Afterwards, the method determines whether the grid frequency is still below the desired range. This is checked in decision step 16. If the grid frequency is still below the desired range, the energy generator simply continues to run. If not, the method continues with step 17, in which the power of the energy generator is reduced, that is to say that the energy generator is ramped down, wherein the energy store starting from this point in time t₃ takes up and stores the energy generated by the energy generator.

Steps 1, 2 and 13 to 17 therefore together yield, analogously to steps 1 to 7, a method according to the invention for an energy store and an energy generator, step 2 only making a decision as to whether or not the grid frequency is above the desired range. The method can also be considered such that decision step 2 takes a decision as to whether the energy store forms a pool with the energy generator or the energy consumer for the subsequent control.

In the strand on the right of the flow chart (steps 1, 2 and 13 to 17), as well, it is possible continuously to check whether or not the grid frequency is below the desired range and then to react accordingly. In this case, too, instead of dedicated measurement of the grid frequency, it is also possible to wait for a request on the part of the grid operator. In the European electrical grid, a grid frequency of 50 Hz is set; in this case, the tolerance is currently ±10 mHz.

FIG. 5 shows a schematic view of a device 20, according to the invention, comprising an energy generator 21 or energy consumer 21 connected to an energy store 22. A controller 23 is connected to the energy generator 21 or energy consumer 21 and to the energy store 22, such that the controller 23 can set the power of the energy generator 21 or energy consumer 21 and the power taken up and output by the energy store 22.

The energy generator 21 or energy consumer 21 and the energy store 22 are connected to an electrical grid 24 and can take up and/or output power from the electrical grid 24. If there is a need for control power—positive or negative control power—the controller 23 receives a signal. The power of the energy generator 21 or energy consumer 21 is subsequently increased. Starting from the point in time t₁, for example after 30 seconds, or shortly beforehand, the power of the energy store 22 is also connected, that is to say that energy is taken up into the energy store 22 or output by the energy store 22.

For this purpose, the controller 23 determines the control power currently provided by the energy generator 21 or energy consumer 21 and ensures that the difference is provided by the energy store 22. If the power of the energy generator 21 or energy consumer 21 starting from the point in time t₂ suffices for providing the entire nominal power of the device 20, the energy store 22 can be disconnected from the electrical grid 24, or switched off, by the controller 23.

On account of the inertia of the systems of the energy generator 21 and energy consumer 21, an overshooting of the control power occurs after the nominal power has been reached. The energy store 22 then takes up the excess energy, or makes available the excess energy. The controller is likewise used for this purpose. Since the energy store 22 was only just discharged or charged in the other direction, this leads to a desired state of charge of the energy store 22 for subsequent control cycles.

At a point in time t₃ the controller 23 receives the signal that the control power is no longer required. The power of the energy generator 21 or energy consumer 21 is reduced. In order that no unnecessary energy is fed into the electrical grid 24 or drawn therefrom, the controller 23 connects the energy store 22 again, which can take up the energy of the energy generator 21 or provide the energy of the energy consumer 21. This measure also leads to an average stage of charge of the energy store 22, such that it has a suitable state of charge for the next control cycle.

In this case, the controller 23 can intelligently charge or discharge the energy store 22, such that a specific desired state of charge is sought. By way of example, tolerances in the case of the overshooting or the points in time t₁, t₂ and/or t₃ can be used to develop the state of charge in the desired direction. In this regard, by way of example, the power of the energy store 22 can already be provided at an earlier point in time than t₁, in order to charge or discharge the energy store 22 if this appears to be necessary. Likewise, an overshoot of up to 10% can be tolerated or absorbed by the energy store 22 in order to control the state of charge of the energy store 22.

In such cases, in particular, an energy store 22 that reacts particularly rapidly and can easily be charged and discharged is required. Rechargeable batteries are best suited for this. Li-ion rechargeable batteries in particular can be quickly and frequently charged and discharged without any harmful influences on the rechargeable battery, and so these are particularly suitable and preferred according to the invention for all of the exemplary embodiments. For this, Li-ion rechargeable batteries with a considerable capacity must be provided. These can for example be easily accommodated in one or more 40-foot ISO containers.

A device 20 according to the invention is therefore particularly well suited as a primary or secondary control power source.

For details concerning the control of control power and concerning information exchange with the grid operators, reference is made to the grid technology/grid operation forum in the VDE (FNN) “TransmissionCode 2007” of November 2009. In particular Appendix D2 therein concerning the pooling of control power units is of interest in order to obtain supplementary observations for the implementation of methods according to the invention.

The features of the invention disclosed in the preceding description, and in the claims, figures and exemplary embodiments can, both individually and in any possible combination, be essential for implementing the invention in its various embodiments.

### LIST OF REFERENCE SIGNS

A Production of power by a conventional power station
B Production of power by a method according to the invention
E, E₂ Energy
E₃ Overshoot energy
P Power
t Time
t₁ First point in time
t₂ Second point in time
t₃ Third point in time
1; 3; 4; 5; 7 Method step
2; 6; 16 Decision step
13; 14; 15; 17 Method step
20 Device for providing control power
21 Energy generator/energy consumer
22 Energy store
23 Controller
24 Electrical grid

1-17. (canceled)

18. A method for providing control power for an electrical grid, wherein an energy generator connected to the electrical grid feeds energy to the electrical grid as necessary or an energy consumer connected to the electrical grid takes up energy from the electrical grid as necessary, wherein
an energy generator and/or an energy consumer is operated together with an energy store connected to the electrical grid for providing the control power,
wherein the energy store starting from a first point in time outputs to the electrical grid at least a difference between power provided by the energy generator and a nominal power or takes up from the electrical grid at least a difference between power taken up by the energy consumer and a nominal power, and the energy store provides at least this difference between the nominal power and the power provided by the energy generator or the power taken up by the energy consumer until the power of the energy generator or of the energy consumer reaches the nominal power at a second point in time.

19. A method according to claim 18, wherein
the energy store starting from a third point in time takes up energy of the energy generator, while the power of the energy generator is reduced, and/or the energy store starting from the third point in time provides energy for the energy consumer, while the power of the energy consumer is reduced.

20. A method according to claim 18, wherein
the energy store used is a flywheel, a heat accumulator, a hydrogen generator and store with fuel cell, a natural gas generator with gas power station, a pumped-storage power station, a compressed-air energy storage power station, a superconducting magnetic energy store, a redox flow element and/or a galvanic element, a rechargeable battery and/or a battery storage power station, or a lithium-ion rechargeable battery.

21. A method according to claim 18, wherein
in the energy store it is possible to store an energy of at least 4 kWh, or at least 10 kWh, or at least 50 kWh, or at least 250 kWh.

22. A method according to claim 18, wherein
the power of the energy store is increased over a period of at least 0.5 s before the first point in time to the first point in time, or over a period of at least 2 s, or over a period of at least 30 s.

23. A method according to claim 18, wherein
the energy generator used is a power station, a coal power station, gas power station, or a hydroelectric power station, and/or the energy consumer used is a factory for manufacturing a substance, or an electrolysis factory or a metal factory, or an aluminium factory or a steel factory.

24. A method according to claim 18, wherein
the energy store at least partly takes up and/or outputs an overshoot energy, the energy store taking up and/or outputting at least 25%, or at least 50%, of the overshoot energy, wherein the overshoot energy is generated in an event of the power of the energy generator overshooting beyond a nominal power and/or it is consumed in an event of the power of the energy consumer overshooting beyond the nominal power, or in a case of changes in the power to be provided.

25. A method according to claim 18, wherein
the nominal power of the energy generator together with the energy store and/or the nominal power of the energy consumer together with the energy store are/is reached by the method within 15 minutes, or within 5 minutes, or within 30 seconds, at least to an extent of 95%.

26. A method according to claim 18, wherein
grid frequency of the electrical grid is measured and control power is output to the electrical grid or taken up from the electrical grid in an event of a deviation from a desired value or a deviation from a tolerance around a desired value and/or the control power is reduced in an event of the grid frequency returning to the desired value or within the tolerance.

27. A method according to claim 18, wherein
the energy store in an event of a reduction in the power of the energy generator is charged to an extent of at least 50%, or is substantially completely charged, and/or the energy store in an event of a reduction in the power of the energy consumer is discharged to less than 50%, and is substantially completely discharged.

28. A method according to claim 18, wherein
the energy store is operated together with an energy generator and an energy consumer, and the energy store in an event of a reduction in the power of the energy generator is charged approximately to an extent of half, or between 25% and 75%, or between 40% and 60%, or between 45% and 55%, or the energy store in an event of a reduction in the power of the energy consumer is discharged approximately to an extent of half, or between 25% and 75%, or between 40% and 60%, or between 45% and 55%.

29. A method according to claim 18, wherein
the power of the energy consumer that is output to the electrical grid or the power of the energy generator that is taken up from the electrical grid, after the first point in time, is measured at a plurality of points in time, or continuously, and a difference with respect to the nominal power is calculated at a plurality of points in time, or continuously, wherein power of the energy store that is output or taken up is set depending on this difference, or the power is set to be exactly equal to this difference or somewhat greater.

30. A method according to claim 18, wherein
the energy generator and/or the energy consumer have/has a maximum power of at least 1 MW, or at least 10 MW, or at least 100 MW.

31. A method according to claim 18, wherein
a capacity of the energy store is at least high enough that in the energy store it is possible to store at least energy required for bridging the nominal power to be provided starting from the first point in time until the nominal power is reached by the energy generator and/or the energy consumer at the second point in time.

32. A device for carrying out a method according to claim 18, comprising a controller, an energy store, and an energy generator and/or an energy consumer, wherein the device is connected to an electrical grid, the controller is connected to the energy store, and the energy consumer and/or the energy generator and controls the control power generated and/or taken up.

33. A device according to claim 32, wherein
the device comprises a frequency measuring unit for measuring grid frequency of the electrical grid and a memory, wherein at least one limit value of the grid frequency is stored in the memory, wherein the controller is configured to compare the grid frequency with the at least one limit value and to control the power of the energy store and of the energy consumer and/or of the energy generator depending on the comparison.

34. A device according to claim 32, wherein
a capacity of the energy store is at least high enough that in the energy store it is possible to store at least energy required for bridging nominal power to be provided starting from the first point in time until nominal power is reached by the energy generator and/or the energy consumer at the second point in time, or the capacity of the energy store is high enough that in the energy store it is possible to store 99% to 150% of energy required for this purpose, or 100% to 120%, or 100% to 110%.
